(19) United States
(12) Patent Application Publication
(10) Pub. No.: US 2024/0076833 A1
(43) Pub. Date: Mar. 7, 2024

(54) ROLL COVER AND ROLL

(71) Applicant: Voith Patent GmbH, Heidenheim (DE)

(72) Inventors: Franz Grohmann, Schmidsdorf (AT); Christine Rinner, Möllersdorf (AT); Werner Dobler, Schottwien (AT); Martin Breineder, Natschbach (AT)

(73) Assignee: Voith Patent GmbH, Heidenhem (DE)

(21) Appl. No.: 18/503,502

(22) Filed: Nov. 7, 2023

Related U.S. Application Data
(63) Continuation of application No. PCT/EP2022/058058, filed on Mar. 28, 2022.

(30) Foreign Application Priority Data
May 12, 2021 (DE) 10 2021 112 362.3

(51) Int. Cl. D21F 3/08; C08G 18/44; C08G 18/76; C08J 5/12; D21F 3/10; D21G 1/00

(52) U.S. Cl. CPC D21F 3/08; C08G 18/44; C08G 18/7614; C08G 18/7685; C08J 5/12; D21F 3/105; D21G 1/0026; D21G 1/0233

(57) ABSTRACT

A roll cover and a roll in particular for use in a machine line for the production or processing of a fibrous web is provided, wherein the roll cover includes a radial outer functional layer which provides the surface of the roll cover in contact with the web, and wherein the functional layer has structural elements, in particular in the form of grooves and/or bores, wherein the functional layer is constructed of an elastomer material with a Poisson number greater than 0.4, between 0.45 and 0.5.

### CROSS REFERENCE TO RELATED APPLICATIONS

This is a continuation of PCT application no. PCT/EP2022/058058, entitled “ROLLER COVER AND ROLLER”, filed Mar. 28, 2022, which is incorporated herein by reference. PCT application no. PCT/EP2022/058058 claims priority to German application no. 10 2021 112 362.3, filed May 12, 2021, which is incorporated herein by reference.

### BACKGROUND OF THE INVENTION

### 1. Field of the Invention

The present invention relates to rolls, and, more particularly, to roll covers.

### 2. Description of the Related Art

In industrial installations such as paper machines, a multitude of rolls are used. These rolls can be used to guide the material web, or to influence the surface properties. Another important area of application for such rolls is pressing and dewatering of the fibrous web. In this process, a press roll with a counter element—often in the embodiment of a counter roll—forms a treatment nip for mechanical dewatering of the fibrous web. The water can then be partially absorbed into structures of the roll surface, such as grooves or (blind) bores. These structures provide a storage capacity for the squeezed-out water.

The problem with rolls with relatively soft roll surfaces is, however, that the cover is compressed by the force acting in the treatment nip, causing the grooves or bores to be completely or at least partially closed up and the storage capacity decreases.

In order to ensure sufficient water absorption capacity and to avoid rewetting of the paper web after it exits the treatment nip, it is proposed in patent specification U.S. Pat. No. 9,488,217 to design the grooves and bores very wide relative to their depth. Specifically, it is proposed that the width or respectively the diameter should be at least 70% of the depth or more.

The disadvantage of this solution, however, is the fact that by widening the grooves and bores, the intermediary bars, in other words the part of the roll surface that is responsible for building up the hydraulic pressure in the treatment nip, necessarily become smaller. This hinders the build-up of the highest possible hydraulic pressure, and thus an intensive squeezing of the web.

In addition, wide grooves and/or large diameter holes often cause marks in the paper. This can occur, for example, in the form of so-called “bore shadow markings”, which are caused by an uneven washing out of fines and fillers from the paper web.

What is needed in the art is to overcome the problems known from the state of the art.

In particular, what is needed in the art is a roll cover or respectively a roll which provides sufficient storage volume and at the same time can build up sufficient hydraulic pressure in the treatment nip.

### SUMMARY OF THE INVENTION

The invention relates to a roll cover for a roll, particularly for use in an installation for the production or processing of a fibrous web, wherein the roll cover includes a radial outer functional layer which provides the surface of the roll cover in contact with the web, and wherein the functional layer has structural elements, in particular in the form of grooves and/or bores. The present invention also relates to a corresponding roll.

Within the framework of this application, the terms material web, fibrous web, and paper web are used interchangeably. This includes in particular pulp webs, webs for graphic paper or packaging paper, cardboard webs, tissue webs, and webs for specialty papers.

In regard to the roll cover, the present invention provides a roll cover for a roll in particular for use in a machine line for the production or processing of a fibrous web, wherein the roll cover includes a radial outer functional layer which provides the surface of the roll cover in contact with the web, and wherein the functional layer has structural elements, in particular in the form of grooves and/or bores.

The present invention provides that the functional layer is composed of an elastomer material that has a Poisson's ratio higher than 0.4.

In particular, provision can be made that the elastomer material has a Poisson's ratio between 0.45 and 0.5, for example 0.47, 0.48 or 0.49.

Optional designs may provide that a polyurethane is used as the elastomer material. Polyurethanes, for example, which contain or are made from polycarbonates, PPDI (paraphenylene diisocyanates) or TODI (0-tolidine diisocyanates) are particularly beneficial.

Alternatively, a rubber material can also be used as an elastomer material, in particular a rubber formulation based on HNBR (hydrogenated acrylonitrile butadiene rubber) or EPDM (ethylene propylene diene rubber).

The Poisson's ratio—also referred to as transverse contraction number, transverse strain or transverse expansion ratio—is a material parameter in mechanics or strength of materials theory. It is used to calculate transverse contraction and is one of the elastic constants of a material.

As is known, the Poisson's ratio is defined as the linearized negative ratio of the relative change in dimension transverse to the uniaxial stress direction to the relative change in length when subjected to a one-dimensional mechanical stress condition:

If a sample (a solid piece of material, for example S1 or S2 strips according to DIN 53504) is stretched by pulling it apart at its ends (“in the longitudinal direction”), this can influence its volume. For a sample whose material has a Poisson ratio close to 0.5, the volume remains (almost) the same. If it is pulled longer, it becomes only just thin enough that its volume remains (practically) the same.

Since the roll covers are often operated at temperatures between 50° C. and 60° C., it would be desirable to also determine the Poisson's ratio at these operating temperatures. However, the effort required to suitably temper the measuring device is relatively great. Therefore, the Poisson's ratios cited within the scope of this application are measured under laboratory conditions, that is at 20° C. The Poisson's ratio hardly changes over a wide range of temperatures. Substantial changes are only to be expected below the glass transition temperature which is in the region of −20° C. for such elastomers, or above 80° C.-100° C. Therefore, a measurement at 20° C. is also representative for use at 50°-60° C.

However, Poisson's ratio measured in the tensile test depends on the traction speed at which the test is carried out. At low speeds (for example 10 mm/min) relaxation effects also occur and are recorded, which are not relevant for the very rapid deformation in the press nip that occurs in practice. No significant speed dependence was detected at speeds greater than 100 mm/min. The described measured values were therefore determined at a speed of 125 mm/min, an initial force of 1N in the range of 1.5-2.5% elongation and a measuring length (Lo) of 25 mm in the case of the 51 strip and 20 mm in the case of the S2 strip. Due to the dispersion of the measured values, the median of at least 3, ideally at least 5, individual measurements was used.

The inventors have recognized that the material behavior of a roll cover in a treatment nip can effectively be characterized by way of this material parameter. In the case of an elastomer material, especially a polyurethane, with a Poisson's ratio above 0.4, especially between 0.45 and 0.5, there are no or only minor undesirable material deformations even at relatively high pressures in the treatment nip. This provides a great deal of freedom to introduce structures into the surface of the roll cover. These structures are then not at all, or only insignificantly, changed in the treatment nip, and their storage capacity is largely retained.

In particular, in contrast to the state of the art, it may be provided that the roll cover has grooves as structural elements, and that the ratio of the groove width to the groove depth is less than or equal to 0.7, in particular less than or equal to 0.68, 0.65, 0.6 or 05.

Alternatively or in addition, it may be provided that the roll cover has bores as structural elements, and that the ratio of the bore diameters to the bore depth is less than or equal to 0.7, in particular less than or equal to 0.68, 0.65, 0.6 or 0.5.

In advantageous applications, the groove width and/or bore diameter may be between 0.7 mm and 1.4 mm, optionally between 0.8 mm and 1.1 mm.

It can moreover be advantageous if the groove depth and/or bore depth is between 1.8 mm and 2.8 mm, in particular between 2 mm and 2.5 mm.

For example, a groove width of 1.1 mm and a groove depth of 2 mm provides a ratio of 0.55. A groove width of 0.8 mm and a groove depth of 2.5 mm results in a ratio of 0.32.

Roll covers according to aspects of the current invention also allow provision of large open areas of up to 40% or 45% in the roll cover. For example, in the case of a grooved roll cover, the open area can be 32%, 33% or 34%. An open area of 33.3% means that with a groove width of 1 mm, the webs between the grooves have a width of 2 mm. In the case of roll covers, which have both grooves and bores, even larger open areas are possible. 33% to 49% are very common in this case.

These structural elements, which are rather deep in comparison to the width or diameter, can provide sufficient storage volume and still build up sufficient hydraulic pressure in the treatment nip.

In particularly advantageous designs, a soft roll cover can be provided. Provision may be made in particular that the hardness of the functional layer is greater than 10 P&J, in particular between 15 P&J and 50 P&J. Hardness values of 20 P&J, 25 P&J, 30 P&J or 35 P&J are common. Such levels of hardness can be achieved very easily, especially with polyurethanes, especially polyurethanes that contain or are made from polycarbonates, PPDI (paraphenylene diisocyanates), or TODI (0-tolidine diisocyanates).

The hardness specifications “P & J” refer to the measurement according to Pusey & Jones. In this measurement, softer materials have higher P&J values. The statement that a roll cover has a greater than 10 P&J therefore means that the cover should be softer than 10 P&J.

The rolls, and especially the roll covers, are exposed to very harsh conditions when used, for example in a paper machine. Mechanical influences such as pressure in a roll nip and friction, but also the chemical influence of the various process waters and process chemicals lead to constant wear and tear of the roll cover. This wear is particularly disturbing in the case of rolls with structural elements, where, as described above, it is advantageous if the depth of the structural elements is relatively large compared to their diameter or width or if a certain ratio is to be maintained (for example width/depth <0.7 or <0.6 mm). If, for example, ¼ of the thickness of the cover is removed due to wear, while the width of the structure remains the same, the width/depth ratio increases by ⅓. As a result, there is a risk that the width/depth ratio will no longer be within the desired range.

Furthermore, the characteristics of the material of the roll covers can also change as a result of the use of the rolls. Depending on the elastomer material used, it can for example lead to hardening or softening of the material or the roll surface.

Especially in the case of polyurethanes, the material properties can change to a greater or lesser extent as a result of hydrolysis.

The products that can provide a constant dewatering performance are stable over a wide range of media.

To assess this consistency, the so-called “Module 10” value has proven to be suitable. This value describes the stress value of the elastomer material at 10% elongation. The “module 10” value is measured in a tensile test on the S1 or S2 strip according to DIN 53504. Suitable test devices are available, for example, from the Zwick company.

For the purpose of evaluating the materials within the framework of this application, the module 10 value is measured before and after storage in water at 110° C. for 96 hours. (To achieve this temperature, the water is under appropriate pressure). Unless otherwise specified, the measurement is taken on the S2 strip.

The elastomers, especially the polyurethanes, lose a certain amount of tension during this storage, generally due to hydrolysis processes.

Standard polyurethanes can herein have a loss of tension of more than 40%, occasionally up to 50%, of the value before hydrolysis.

However, it has become evident that a high loss of tension is negative for the stability of the materials. Advantageously, when stored in water at 110° C. for 96 hours, the module 10 value should only change by 20% or less. Materials where the change is a maximum of 10% are optional.

According to one aspect of the present invention, a wide range of possible materials are available for possible polyurethanes (PU) to be used as elastomers for a roll cover.

Polyols that can be used for PU production are for example: polyether with a molecular weight of 250-3000 g/mol, polybutadiene with 250-3000 g/mol, or polycarbonates with 250-3000 g/mol.

Both, aromatic and aliphatic diisocyanates—for example diphenylmethane diisocyanate, toluene diisocyanate or hexamethylene diisocyanate—are suitable as diisocyanates for PU production.

Diamines such as MCDEA or MOCA as well as short-chain diols such as 1.4-butanediol or trifunctional products such as trimethylolpropane are suitable as chain extenders or crosslinkers.

This list is only intended to provide examples; however, the present invention is not limited to the use of these materials.

In regard to the roll, the present invention provides a roll for a machine line for producing or processing of a fibrous web including a substantially cylindrical roll core and a roll cover applied to it, wherein the roll cover is designed according to one aspect of the present invention.

### DETAILED DESCRIPTION OF THE INVENTION

The present invention is further explained below, with reference to examples.

The examples specify some examples of elastomers suitable for use in a roll cover according to one aspect of the present invention. These are different polyurethanes. However, the present invention is not limited to these exemplary formulations.

The following table shows examples of 4 different types of polyurethanes. The first PU_PC is a PU on the basis of a polycarbonate polyol with an MDI as an isocyanate.

The other three PUs (TODI 1, 2 and 3) each use TODI and the same crosslinking agent as isocyanate but differ in the polyol used.

| | PU PC | PU TODI 1 | PU TODI 2 | PU TODI 3 |
|---|---|---|---|---|
| Isocyanate | MDI | TODI | TODI | TODI |
| Polyol | Polycarbonate | Polyether | Polycarbonate | Polycaprolactone |
| | polyol | | polyol | polyol |
| Crosslink | MCDEA | 1.4-Butanediol | 1.4-Butanediol | 1.4-Butanediol |
| Agent | | | | |

The following table shows the measured module 10 values before and after storage and

compares them with a standard PU.

For all materials used, the Poisson's ratio is between 0.45 and 0.5.

| | Before storage | After storage | Loss [%] |
|---|---|---|---|
| Standard PU | 4.3 | 2.2 | 48.8% |
| PU PC | 3.4 | 2.8 | 17.0% |
| PU TODI 1 | 4.9 | 4.5 | 8.3% |
| PU TODI 2 | 4.9 | 4.5 | 7.9% |
| PU TODI 3 | 4.1 | 3.9 | 5.6% |

As the comparison of the PU PC with the standard PU shows, use of polycarbonate polyols is advantageous for Module 10 stability. Instead of a loss of almost 50% for standard PU, the loss for PU PC is significantly less than 20%.

It is also clear that the samples in which TODI were used as isocyanate show excellent results, almost regardless of the polyol used. The loss is less than 10% respectively. All these materials with a module 10 loss of less than 20%, especially less than 10%, are very beneficial for use in a roll cover according to one aspect of the present invention!

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A roll cover for a roll, the roll cover comprising:
a surface configured for being in contact with a web of fibrous material, the surface being formed by a radial outer functional layer, the radial outer functional layer including a plurality of structural elements and being composed of an elastomer material that has a Poisson's ratio greater than 0.4.

2. The roll cover according to claim 1, wherein the roll cover is configured for the roll which is configured for being used in a machine line for producing or processing the web of fibrous material, wherein the plurality of structural elements are at least one of a plurality of grooves and a plurality of bores, and wherein the Poisson's ratio is between 0.45 and 0.5.

3. The roll cover according to claim 1, wherein a polyurethane is used as the elastomer material.

4. The roll cover according to claim 3, wherein the polyurethane includes or is made from at least one polycarbonate polyol.

5. The roll cover according to claim 1, wherein a polyurethane is used as the elastomer material, the polyurethane including or being made from at least one of (a) at least one 0-tolidine diisocyanate (TODI) and (b) one paraphenylene diisocyanate (PPDI).

6. The roll cover according to claim 1, wherein the plurality of structural elements includes a plurality of grooves each of which includes a groove width and a groove depth, and wherein a ratio of the groove width to the groove depth is less than or equal to 0.7.

7. The roll cover according to claim 6, wherein the ratio of the groove width to the groove depth is less than or equal to 0.5.

8. The roll cover according to claim 1, wherein the plurality of structural elements includes a plurality of bores each of which includes a bore diameter and a bore depth, and wherein a ratio of the bore diameter to the bore depth is less than or equal to 0.7.

9. The roll cover according to claim 8, wherein the ratio of the bore diameter to the bore depth is less than or equal to 0.5.

10. The roll cover according to claim 1, wherein a hardness of the radial outer functional layer is greater than 10 P&J.

11. The roll cover according to claim 10, wherein the hardness of the radial outer functional layer is between 15 P&J and 50 P&J.

12. The roll cover according to claim 1, wherein a tensile stress value of the elastomer material changes by less than 20%, at 10% elongation (“module 10”, measured in a tensile test on an S2 strip according to DIN 53504) during 96 hours of storage at 110° C. in water pH=7.

13. The roll cover according to claim 12, wherein the tensile stress value of the elastomer material changes by less than 10%.

14. A roll for a machine line for producing or processing a web of fibrous material, the roll comprising:
a roll core which is substantially cylindrical; and
a roll cover applied to the roll core, wherein the roll cover includes a surface configured for being in contact with the web of fibrous material, the surface being formed by a radial outer functional layer, the radial outer functional layer including a plurality of structural elements and being composed of an elastomer material that has a Poisson's ratio greater than 0.4.
